(19) United States
(12) Patent Application Publication
(10) Pub. No.: US 2021/0219709 A1
(43) Pub. Date: Jul. 22, 2021

(54) TOOTHBRUSH

(71) Applicant: WORLD WIDE DAILY HOLDINGS COMPANY LIMITED, |NewTerritories, Hong Kong (CN)

(72) Inventor: Chun Yuen TO, N.T. Hong Kong (CN)

(21) Appl. No.: 16/310,772

(22) PCT Filed: Oct. 9, 2018
(86) PCT No.: PCT/CN2018/109457

§ 371 Date: Dec. 17, 2018

(30) Foreign Application Priority Data
Dec. 21, 2017 (CN) PCT/CN2017/117704

(51) Int. Cl. A46B 9/02; A46B 9/04; A46B 9/06

(52) U.S. Cl. CPC A46B 9/025; A46B 9/04; A46B 2200/1066; A46B 9/06; A46B 9/028; A46B 9/026

(57) ABSTRACT

A toothbrush includes a handle and a head connected to an end of the handle. The head has a surface. A plurality of bristles are mounted on the head so the bristles extend from the surface on only one side of the head. The plurality of bristles are arranged in a plurality of sets including first, second, and third sets. The bristles of each of the first, second, and third sets are substantially parallel to other bristles in the same respective set. The bristles in the first and third sets are oriented to angle outwardly from the bristles in the second set as they extend away from the surface.

### FIELD OF THE INVENTION

The present invention relates generally to toothbrushes, and more particularly to a configuration of a toothbrush head.

### BACKGROUND

People have used toothbrushes to clean their teeth for many years. In general, a conventional toothbrush includes a handle connected to a head at one end of the handle. The head of the toothbrush has a plurality of bristles or other cleaning structures that are designed to contact the surface of the tooth and scrub plaque and other material from the tooth. While the conventional toothbrushes are able to clean teeth in a satisfactory manner, the present inventor has developed an improved toothbrush, which will be described in detail below.

### SUMMARY

In one aspect, a toothbrush generally comprises a handle and a head connected to an end of the handle. The head has a convex surface. A plurality of bristles are mounted on the head so the bristles extend from the convex surface on only one side of the head. The plurality of bristles are arranged in a plurality of sets comprising first, second, and third sets. The bristles of each of the first, second, and third sets are substantially parallel to other bristles in the same respective set. The bristles in the first and third sets are oriented to angle outwardly from the bristles in the second set as they extend away from the convex surface.

Other objects and features will be in part apparent and in part pointed out hereinafter.

### BRIEF DESCRIPTION OF THE DRAWINGS

FIG. 1 is a perspective of one embodiment of a toothbrush of the present invention;

FIG. 2 is a top plan view of the toothbrush in FIG. 1;

FIG. 2A is an enlarged fragmentary view of the toothbrush in FIG. 2;

FIG. 3 is a front elevation of the toothbrush in FIGS. 1 and 2;

FIG. 4 is a bottom plan view of the toothbrush in FIGS. 1-3;

FIG. 5 is an enlarged cross sectional view of the toothbrush in FIGS. 1-4 taken in a plane including line 5-5 on FIG. 2;

FIG. 6 is an enlarged fragmentary perspective of the toothbrush in FIGS. 1-5 showing the head of the toothbrush;

FIG. 7 is an enlarged fragmentary perspective of the toothbrush in FIGS. 1-6 that is similar to FIG. 6 except that the bristles are removed to illustrate one embodiment of an arrangement of openings in the toothbrush head for the bristles;

FIG. 8 is a perspective of another embodiment of a toothbrush of the present invention;

FIG. 9 is a top plan view of the toothbrush in FIG. 8;

FIG. 10 is a front elevation of the toothbrush in FIGS. 8 and 9;

FIG. 11 is a bottom plan view of the toothbrush in FIGS. 8-10;

FIG. 12 is an enlarged cross sectional view of the toothbrush in FIGS. 8-11 taken in a plane including line 12-12 on FIG. 9;

FIG. 13 is an enlarged fragmentary perspective of the toothbrush in FIGS. 8-12 showing the head of the toothbrush;

FIG. 14 is a perspective of another embodiment of a toothbrush of the present invention;

FIG. 15 is a top plan view of the toothbrush in FIG. 14;

FIG. 16 is a front elevation of the toothbrush in FIGS. 14 and 15;

FIG. 17 is a bottom plan view of the toothbrush in FIGS. 14-16;

FIG. 18 is an enlarged cross sectional view of the toothbrush in FIGS. 14-17 taken in a plane including line 18-18 on FIG. 15;

FIG. 19 is an enlarged fragmentary perspective of the toothbrush in FIGS. 14-18 showing the head of the toothbrush;

FIG. 20 is a perspective of one embodiment of a toothbrush of the present invention;

FIG. 21 is a top plan view of the toothbrush in FIG. 20;

FIG. 21A is an enlarged fragmentary view of the toothbrush in FIG. 21;

FIG. 22 is a front elevation of the toothbrush in FIGS. 20 and 21;

FIG. 23 is a bottom plan view of the toothbrush in FIGS. 20-22;

FIG. 24 is an enlarged cross sectional view of the toothbrush in FIGS. 20-23 taken in a plane including line 24-24 on FIG. 21;

FIG. 25 is an enlarged fragmentary perspective of the toothbrush in FIGS. 20-24 showing the head of the toothbrush;

FIG. 26 is an enlarged fragmentary perspective of the toothbrush in FIGS. 20-25 that is similar to FIG. 25 except that the bristles are removed to illustrate one embodiment of an arrangement of openings in the toothbrush head for the bristles;

FIG. 27 is the cross sectional view of FIG. 24 with the bristles removed to show the openings;

FIG. 28 is a longitudinal section of the toothbrush head with the bristles removed to show the openings;

FIG. 29 is an enlarged fragmentary top plan view of a toothbrush head of another embodiment with bristles removed to show openings;

FIG. 30 is a cross sectional view of the toothbrush head in FIG. 29;

FIG. 31 is a longitudinal sectional view of the toothbrush head in FIG. 29;

FIG. 32 is an enlarged fragmentary top plan view of a toothbrush head of another embodiment with bristles removed to show openings;

FIG. 33 is a cross sectional view of the toothbrush head in FIG. 32;

FIG. 34 is a longitudinal sectional view of the toothbrush head in FIG. 32;

FIG. 35 is an enlarged fragmentary top plan view of a toothbrush head of another embodiment with bristles removed to show openings;

FIG. 36 is a cross sectional view of the toothbrush head in FIG. 35;

FIG. 37 is a longitudinal sectional view of the toothbrush head in FIG. 35;

FIG. 38 is an enlarged fragmentary top plan view of a toothbrush head of another embodiment with bristles removed to show openings;

FIG. 39 is a cross sectional view of the toothbrush head in FIG. 38;

FIG. 40 is a longitudinal sectional view of the toothbrush head in FIG. 38;

FIG. 41 is an enlarged fragmentary top plan view of a toothbrush head of another embodiment with bristles removed to show openings;

FIG. 42 is a cross sectional view of the toothbrush head in FIG. 41; and

FIG. 43 is a longitudinal sectional view of the toothbrush head in FIG. 41.

Corresponding reference characters indicate corresponding parts throughout the drawings.

### DETAILED DESCRIPTION

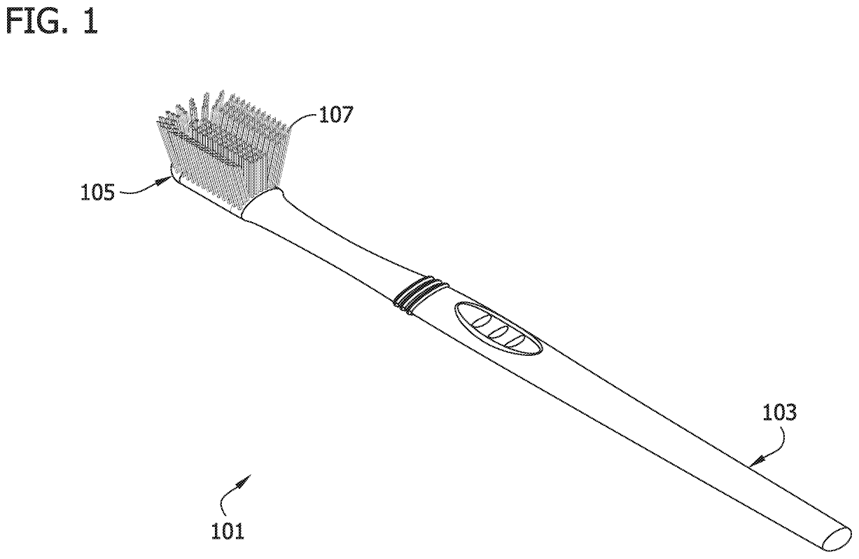

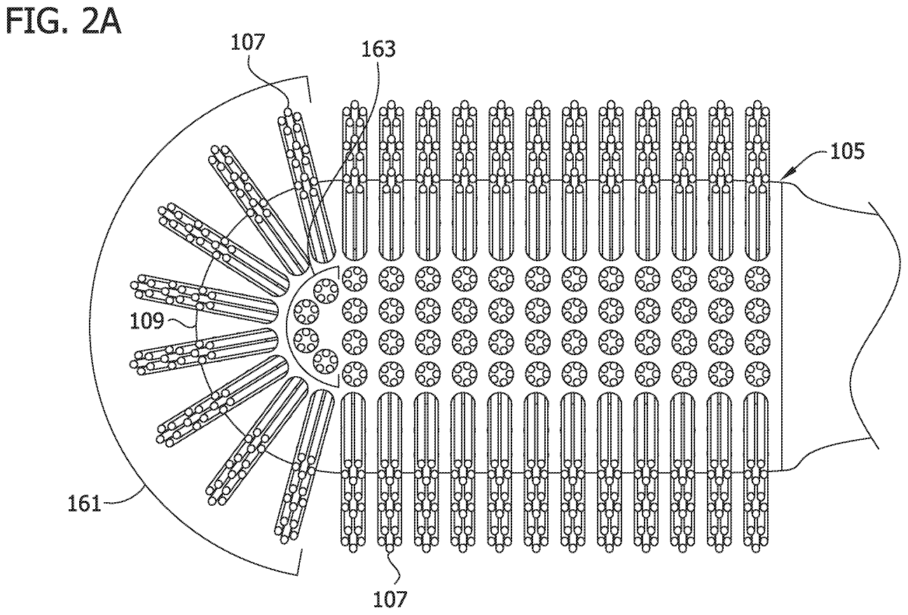

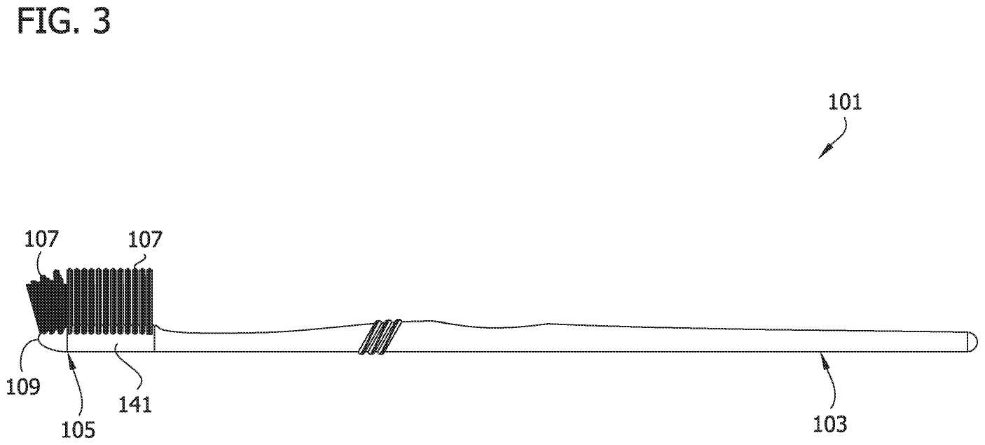

Referring first to FIGS. 1-7, one embodiment of a toothbrush is generally designated 101. The toothbrush 101 is sized and shaped for use by people to brush their teeth. The tooth brush 101 includes a handle 103 and a head 105 connected to an end of the handle. The handle 103 is suitably a conventional handle. The handle 103 is an elongate member sized and shaped to fit comfortably in a person's hand (not shown) while the person holds the toothbrush 101 so the head 105 is inside the person's mouth. The size and shape of the handle can vary from what is shown in the drawings if desired.

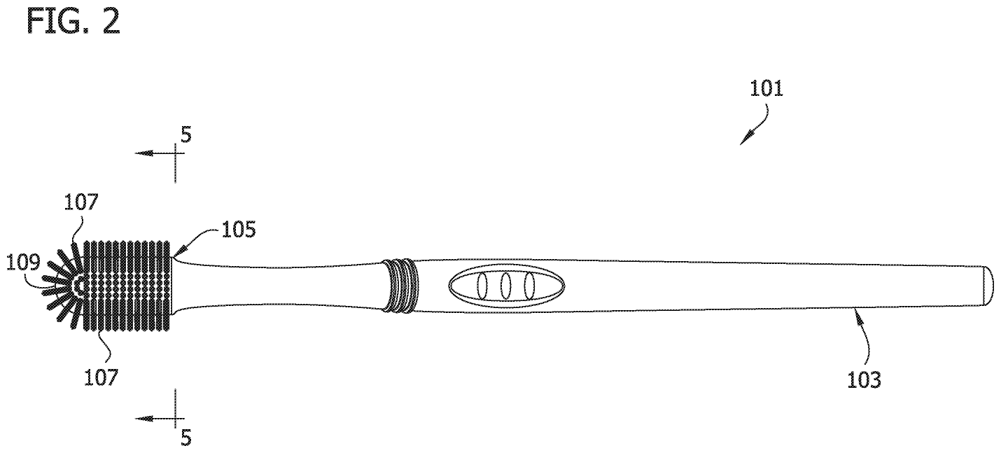

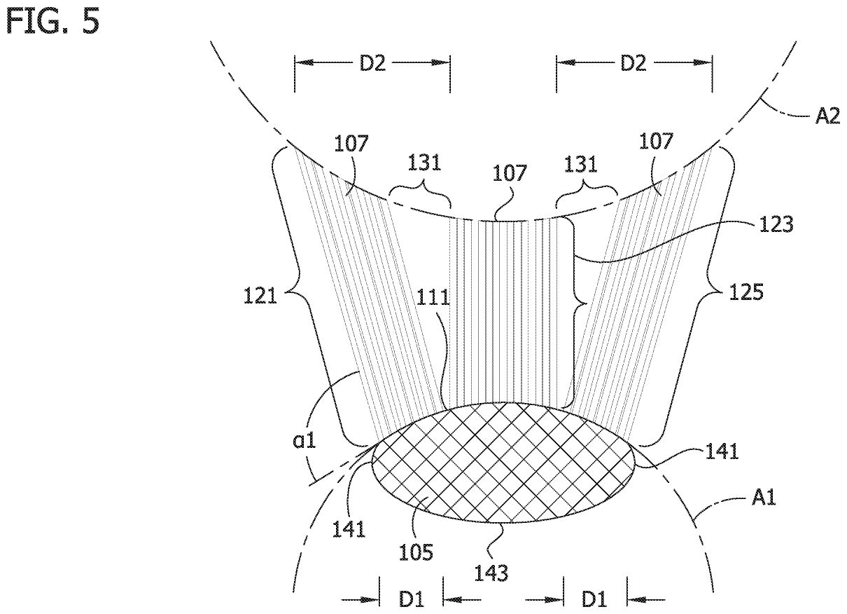

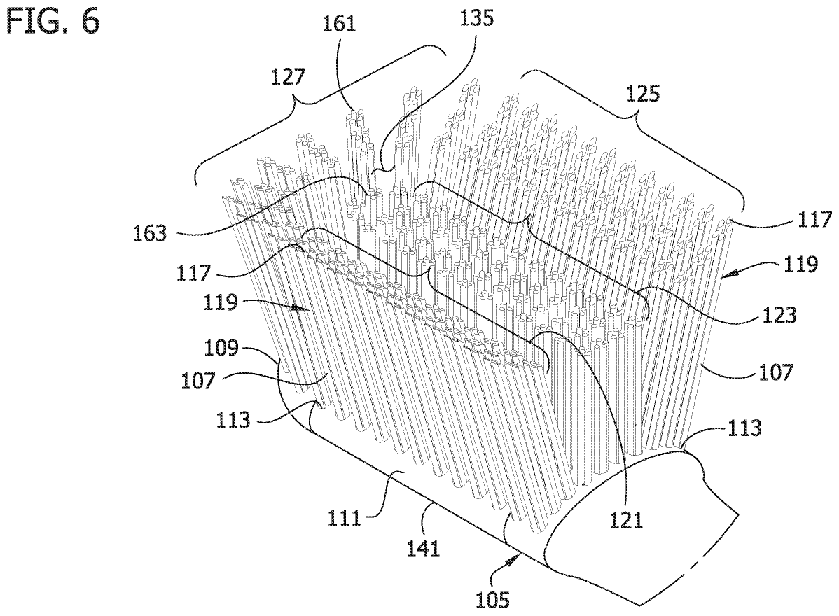

The head 105 of the toothbrush 101 includes a convex surface 111 (see FIGS. 5-7) for carrying a plurality of bristles 107 thereon. The convex surface 111 may be referred to as an “upper” surface herein for convenience, but it is understood the orientation of the toothbrush 101 can be changed from what is shown in the drawings and that the convex surface can be on the side or bottom of the toothbrush depending on how it is held. The head 105 is suitably formed integrally with the handle 103. For example, the head 105 and handle 103 are suitably molded together as one-piece from a polymeric material. The end 109 of the head 105 opposite the handle 103 is suitably rounded, as illustrated in FIGS. 2-4. Referring to FIGS. 5 and 6, the head 105 suitably has relatively narrow rounded sides 141. The sides 141 are suitably substantially parallel to one another and substantially parallel to the handle 103.

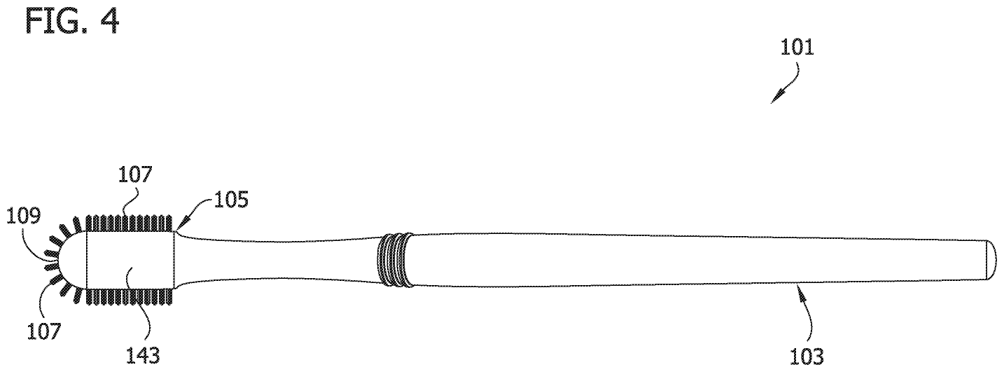

The head 105 also has a surface 143, which may be referred to herein as the “bottom” of the toothbrush head (see FIGS. 4 and 5) that is opposite the convex “upper” surface 111. The shape of the bottom surface 143 can vary. However, in the illustrated embodiment, the bottom surface 143 is convex. For example, the bottom surface 143 is suitably substantially congruent with the convex upper surface 111. Referring to FIG. 5, the head 105 of the toothbrush 101 suitably has a cross sectional shape that is substantially oval or elliptical. For example, the convex upper surface 111 is suitably substantially cylindrical, as indicated by the fact the points on the convex upper surface in FIG. 5 all lie on the same circular arc A1. The bottom surface 143 is also suitably substantially cylindrical. The sides 141 are suitably configured to smoothly transition between the upper and lower surfaces 111, 143, which results in an oval cross sectional shape. However, it is understood the cross sectional shape may be different from what is illustrated in the drawings, including without limitation an elliptical shape and other oval shapes.

The bristles 107 are mounted on the head 105 so the bristles extend from the convex surface 111. For example, in the illustrated embodiment, the bristles 107 are arranged so they only extend from one side of the head 105. For example, there are suitably no bristles extending from the bottom surface 143 of the head 105. The bristles 107 each have a base 113 that extends through an opening 115 in the convex surface 111 and a distal end 117 spaced from the convex surface. The bristles 107 are suitably arranged in tufts 119. For example, each tuft 119 is suitably formed by a group of bristles 107 arranged so the multiple bristles in that group all extend through a single one of the openings 115 in the convex surface 111.

Referring to FIGS. 5 and 6, the bristles 107 are arranged in multiple different sets. As illustrated in FIG. 6, the bristles are arranged in first, second, third, and fourth sets 121, 123, 125, 127. The first, second, and third sets 121, 123, 125 are visible in FIG. 5. The fourth set 127 is located at the end of the toothbrush head 105 opposite the handle 103 and is visible in FIG. 6, but not in FIG. 5. It is understood that the number of sets can vary if desired. Also, one or more of the sets can be subdivided into subsets if desired.

Referring to FIGS. 5 and 6, the bristles 107 of each of the first 121, second 123, and third 125 sets are substantially parallel to the other bristles in the same respective set. The bristles 107 in the first 121, second 123, and third 125 sets are also arranged so the bristles in each set are in a generally rectangular formation extending generally parallel to the handle 103. For example, the bristles 107 in the first 121, second 123, and third 125 sets are suitably arranged in longitudinal rows that are substantially parallel to one another and substantially parallel to the handle 103.

The bristles 107 in the first 121 and third 125 sets are suitably oriented so they angle outwardly from the bristles in the second 123 set as they extend away from the convex surface 111. Referring to FIG. 5, a distance D1 between the bases 113 of the bristles 107 in the first set 121 and the adjacent bases of the bristles in the second set 123 is less than the distance D2 between the distal ends 117 of the bristles in the first set and the distal ends of the bristles in the second set. Accordingly, there is a significant gap 131 between the distal ends 117 of the bristles 107 in the first set 121 and the distal ends of the bristles in the second set 123. Also, the distance D1 between the bases 113 of the bristles 107 in the third set 125 and the adjacent bases of the bristles in the second set 123 is less than a distance D2 between the distal ends 117 of the bristles in the third set and the distal ends of the bristles in the second set. Thus, there is another gap 131 between the distal ends 117 of the bristles 107 in the second set 123 and the distal ends of the bristles in the third set 125. The gaps 131 between the ends 117 of the bristles 107 in the second set 123 and the first and third sets 125 are suitably oriented to extend generally parallel to the handle 103. In the illustrated embodiment, the gaps 131 are substantially equal in width. The gaps 131 are also suitably substantially uniform in width along the entire length of the gaps.

Still referring to FIG. 5, the bristles 107 in the first set 121 and third set 125 are arranged so they intersect the convex surface 111 of the toothbrush head 105 at one or more non-orthogonal angles α1. For example, the angle α1 between the outermost bristles 107 extending along the sides 141 of the toothbrush head 105 is suitably at least about 110 degrees.

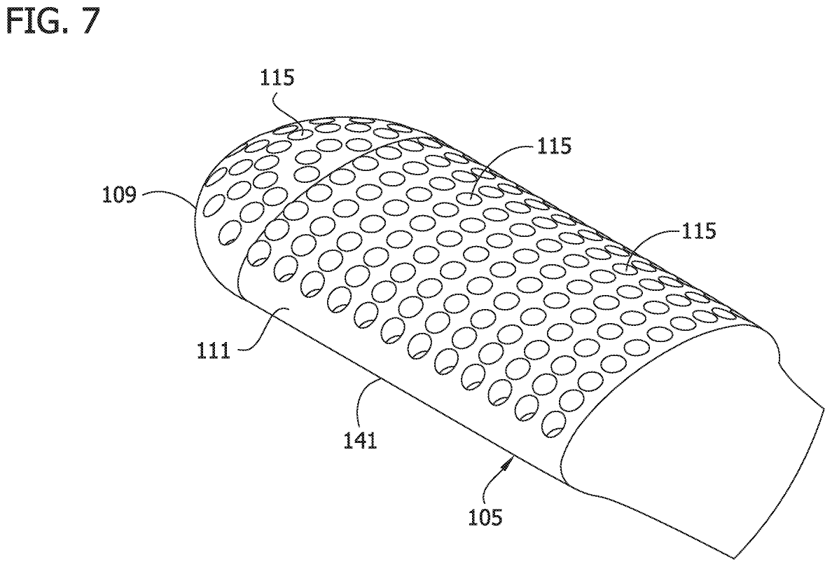

Referring to FIG. 7, the openings 115 in the convex surface 111 for the bristles 107 in the first 121, second 123, and third 125 sets are arranged in an array. The array is configured so the openings 115 are arranged in rows extending generally transverse to the handle 103 and columns extending generally parallel to the handle. The openings 115 in each row are spaced from one another at substantially uniform intervals along the row and include openings that contain tufts 119 of bristles in the first 121, second 123, and third 125 sets of bristles. The openings 115 in each column of the array are spaced from one another at substantially uniform intervals. However, the intervals between the openings 115 in each column of the array are larger than the intervals between the openings in each row. In contrast to the openings 115 in the rows, the openings in each column contain tufts 119 of bristles from only a single one of the first 121, second 123, and third 125 sets.

Referring to FIG. 6, the bristles 107 in the fourth set 127 are positioned so the bristles in the first 121, second 123, and third 125 sets are located between the fourth set and the handle 103. For example, the bristles 107 in the fourth set are suitably positioned on the rounded end 109 of the toothbrush head 105. The bristles 107 in the fourth set 127 are suitably arranged in an arcuate configuration. For example, the bristles 107 in the fourth set 127 suitably include a band 161 of bristles extending in an arcuate configuration from an end of the first 121 set to and end of the third set 125. In one embodiment, the band 161 is defined by at least three tufts 119 of bristles 107. In one embodiment, the band 161 is defined by at least four tufts 119 of bristles 107. Another group 163 of bristles 107 in the fourth set 127 are spaced inward from this band 161 and positioned adjacent an end of the second set 123 of bristles. As illustrated in FIG. 6, the bristles in this group 163 of bristles within the fourth set 127 are also arranged in a band thereby forming an inner band of the fourth set 127 of bristles 107. In the illustrated embodiment the bristles 107 in the outer band 161 and inner band 163 are concentrically spaced from one another. Thus there is an arcuate gap 135 between the outer and inner bands 161, 163 of the fourth set 127 of bristles 107.

The gap 135 suitably extends between the ends of the gaps 131 between the second set 123 of bristles 107 and the first and third sets 121, 125 of bristles. Collectively, the gaps 131, 135 form a horseshoe shaped gap in the bristles 107 with the open end of the horseshoe facing the handle 103. The width of the gap 135 is suitably substantially uniform along its length. The width of the gap 135 between the outer and inner bands 161, 163 is also substantially identical to the widths of the gaps 131 between the second set 123 of bristles 107 and the first and third sets 121, 125. Accordingly, the horseshoe shaped gap that is collectively formed by the gaps 131, 135 suitably has a substantially uniform width over its entire length.

The arrangement of the bristles 107 described herein offers several advantages. For example, the bristles 107 are arranged so there are sets of bristles 121, 123, 125, having the distal ends 117 positioned relatively closely to one another. At the same time, there are significant gaps 131, 135 in between some of the bristles. The ends 117 of the bristles 107 that are spaced relatively closely to one another work collectively to provide a brushing action on the person's tooth. If one or a handful of these bristles contacts a tooth, gum, or piece of debris, it may flex and yield, but bristles that are adjacent the flexed bristle in the same set will also likely encounter the same object at the same time or shortly thereafter. On the other hand, the gaps 131, 135 between the various sets of bristles 107 at their ends 117 provide multiple bristle-free spaces into which debris can fall after it has been dislodged by the ends 117 of the bristles 107, allowing for the debris to be more easily removed from the teeth.

Although there are substantial gaps 131, 135 between the ends 117 of the bristles in the different sets 121, 123, 125, 127, the bases 113 of the bristles are arranged in a relatively dense pattern. This helps minimize the amount of material used in the head 105, which in turn helps keep the weight and cost of the toothbrush 101 to a minimum. This can also help the user manipulate the toothbrush head 105 better while it is inside the mouth.

The lengths of the bristles 107 in the first through fourth sets 121, 123, 125, 127 are varied so that the distal ends 117 of the bristles 107 collectively form a concave brushing surface. As illustrated in FIG. 5 for example, the distal ends 117 of the bristles all lie on an arcuate surface A2 (such as a substantially cylindrical surface). Relatedly, the bristles 107 in the first 121 and third 125 sets are longer than the bristles in the second set 123. Meanwhile, the bristles in the fourth set 127 that lie on the central axis of the toothbrush 101 are shorter than the bristles that are adjacent the sides 141 of the toothbrush head 105. A concave brushing surface A2 may be desired by some because this type of brushing surface is good at wrapping around the corners of a person's teeth.

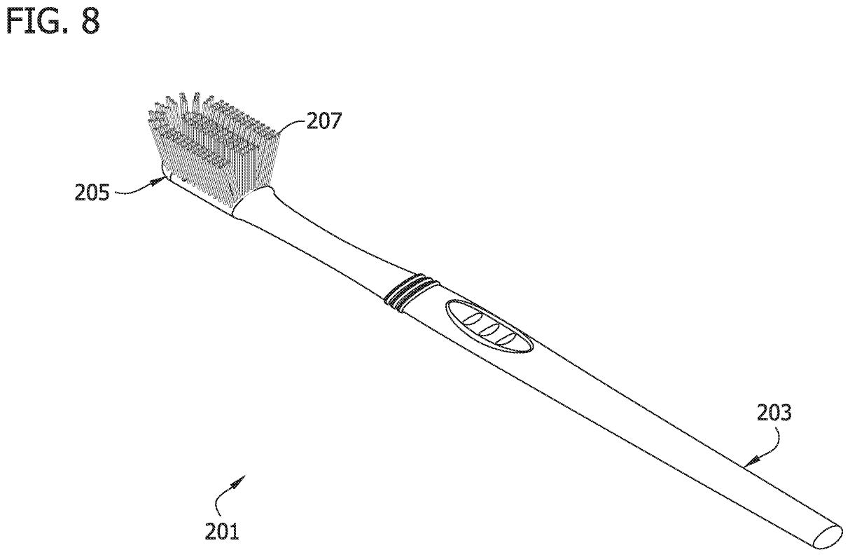

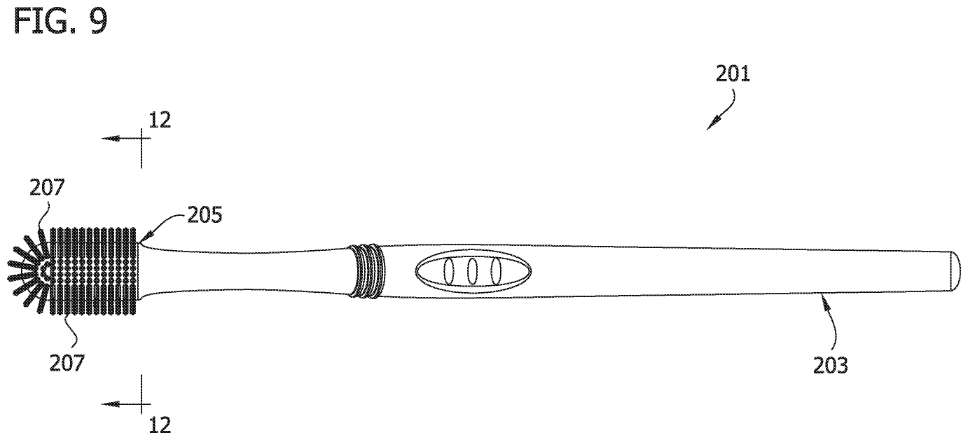

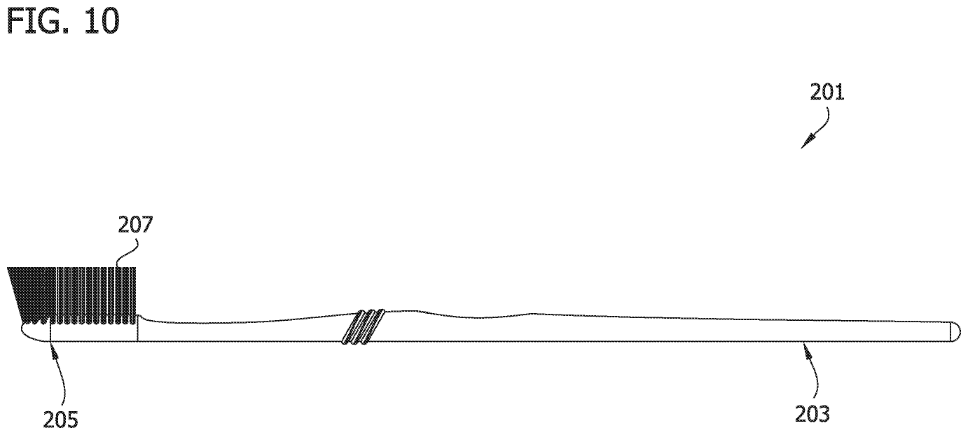

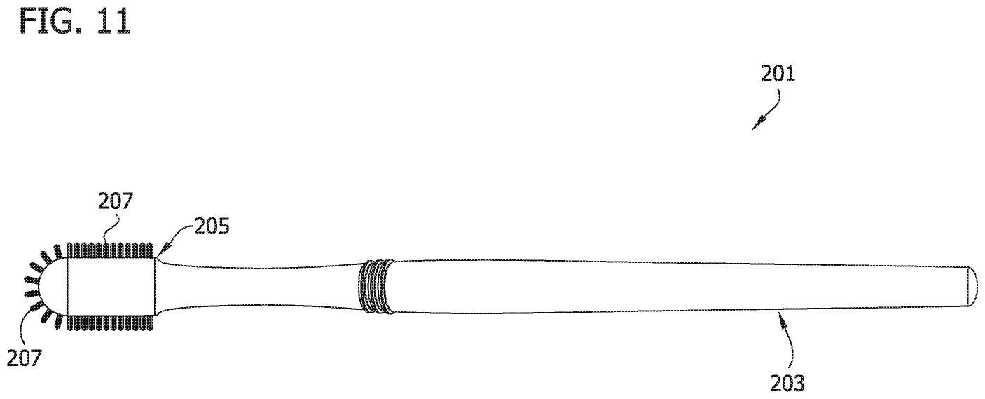

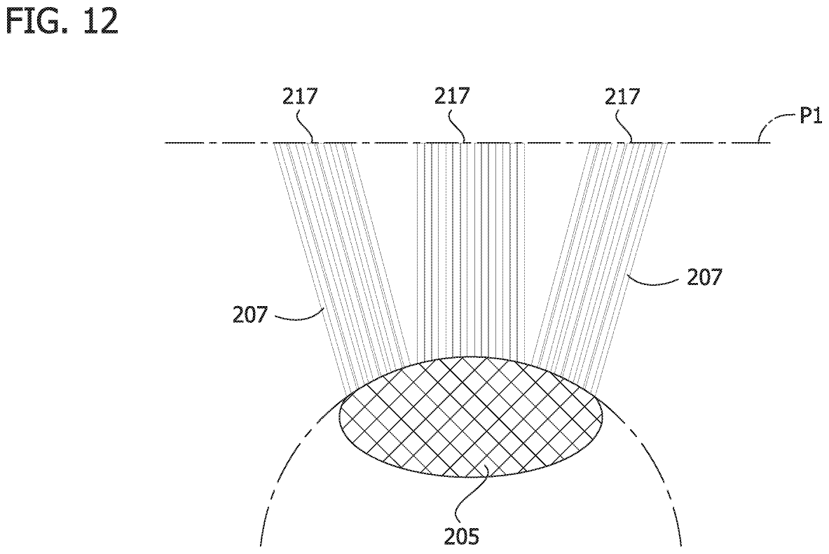

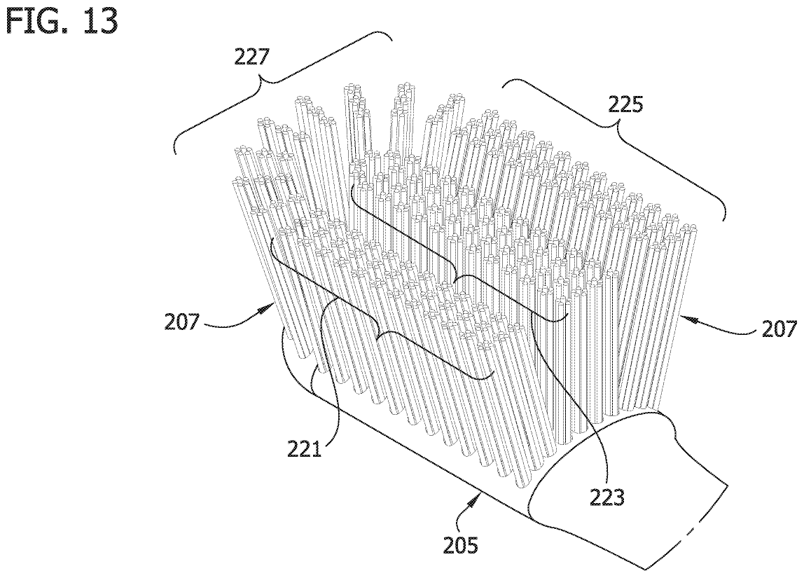

FIGS. 8-13 illustrate another embodiment of a toothbrush, generally designated 201, which is substantially identical to the toothbrush 101 described above except as noted. The bristles 207 of this toothbrush 201 are arranged in first, second, third, and fourth sets 221, 223, 225, 227, which are positioned and arranged in the same way as the sets 121, 123, 125, 127 described above. However, the lengths of the bristles 207 differ from the lengths of the bristles 107. In particular, referring to FIG. 12, the lengths of the bristles 207 are varied so that the distal ends 217 of the bristles all lie on a planar brushing surface P1. A planar brushing surface P1 may be desired by some because this type of brushing surface is good at removing material from the opposing surfaces of the back molars.

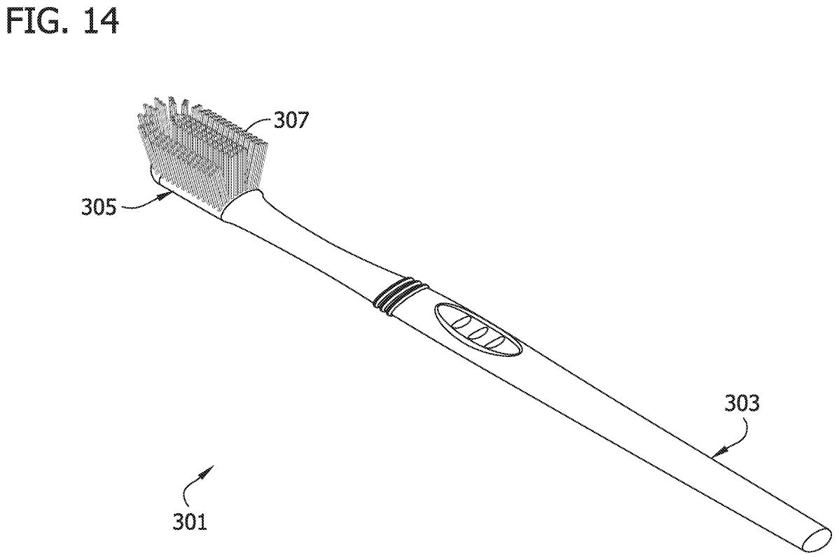

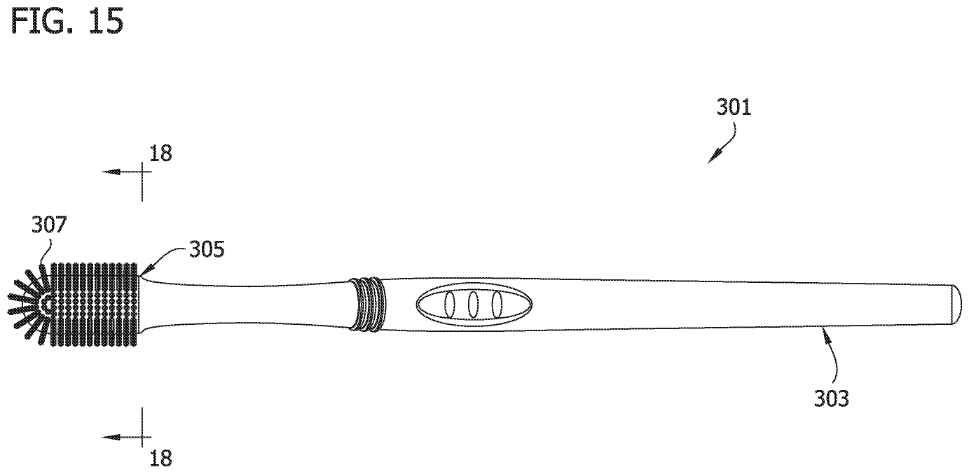

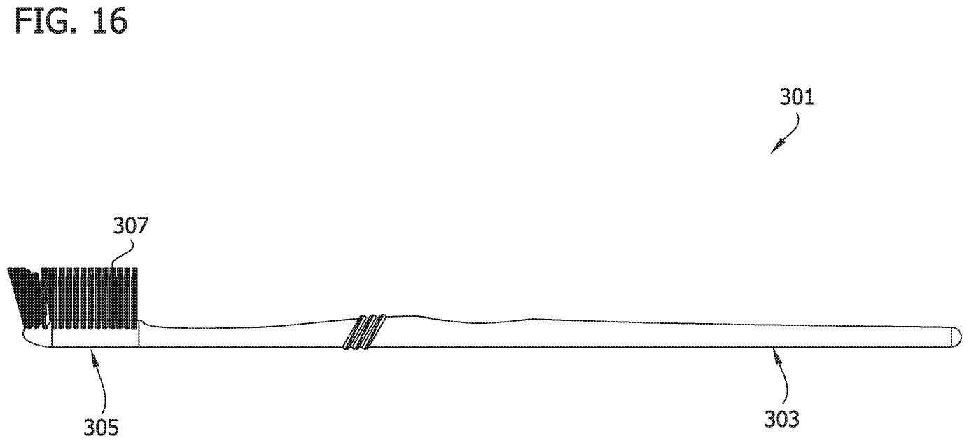

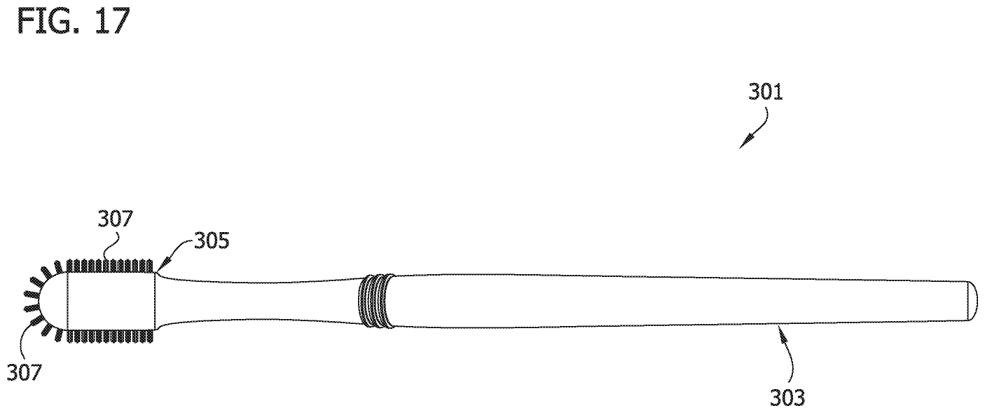

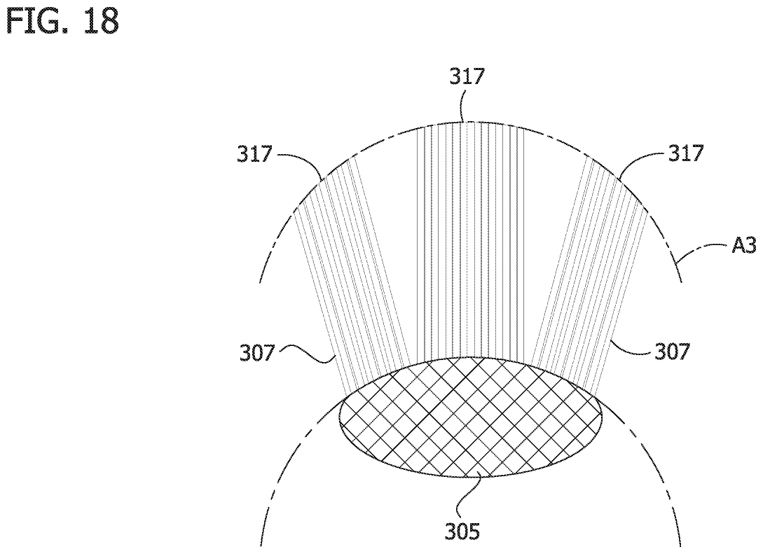

FIGS. 14-19 illustrate another embodiment of a toothbrush, generally designated 301, which is substantially identical to the toothbrush 101 described above except as noted. The bristles 307 of this toothbrush 301 are arranged in first, second, third, and fourth sets 321, 323, 325, 327, which are positioned and arranged in the same way as the sets 121, 123, 125, 127 described above. However, the lengths of the bristles 307 differ from the lengths of the bristles 107. In particular, referring to FIG. 18, the lengths of the bristles 307 are varied so that the distal ends 317 of the bristles all lie on a convex brushing surface A3. A convex brushing surface A3 may be desired by some because this type of brushing surface is good at removing material from the inner surfaces of the front teeth.

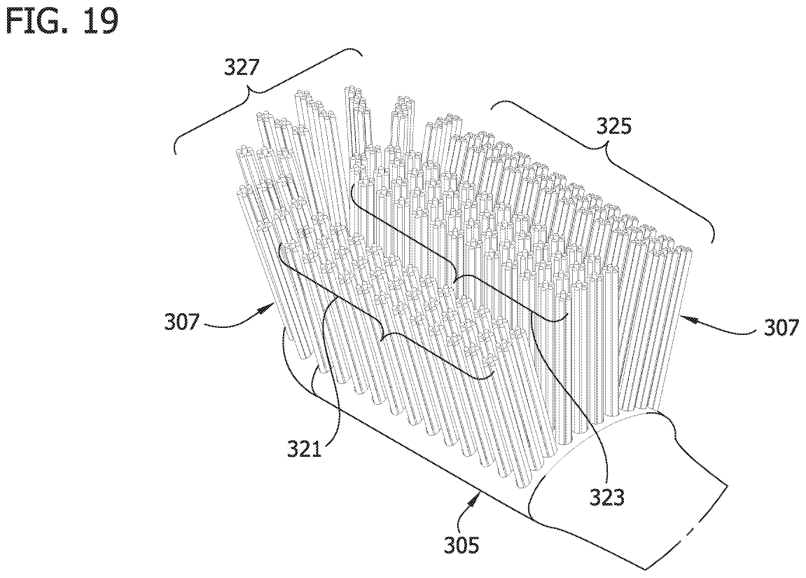

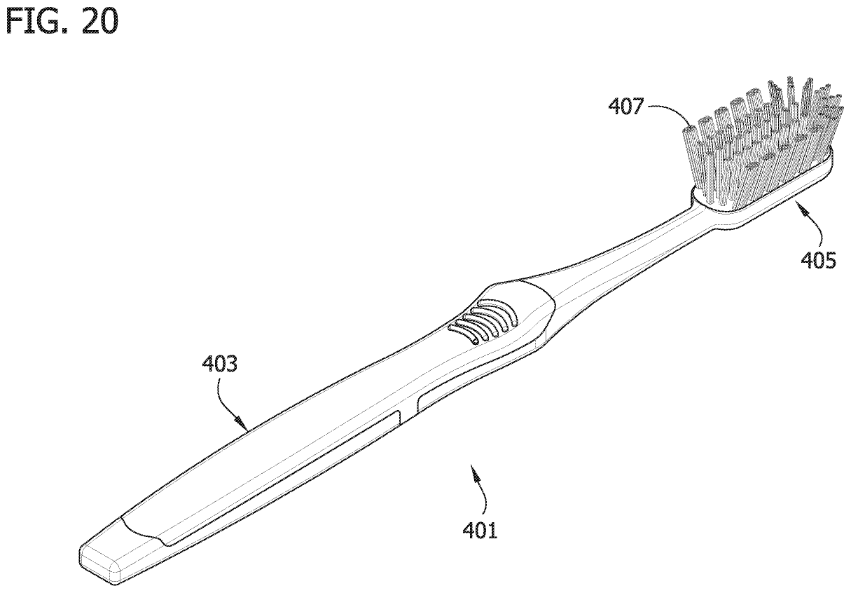

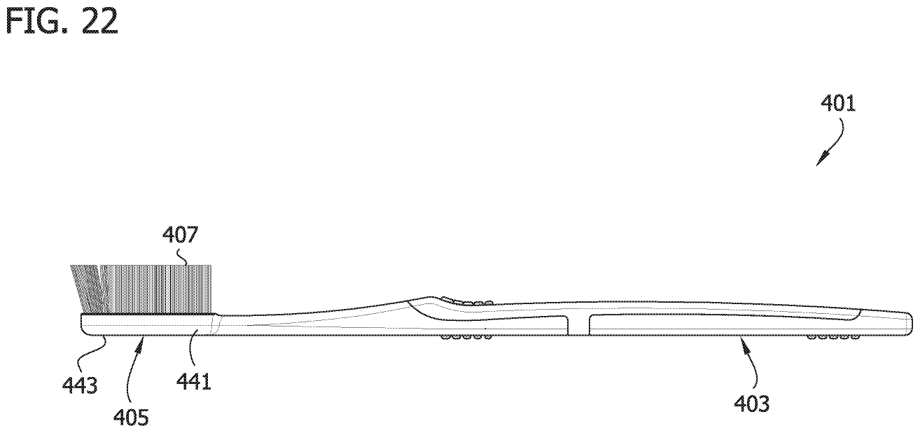

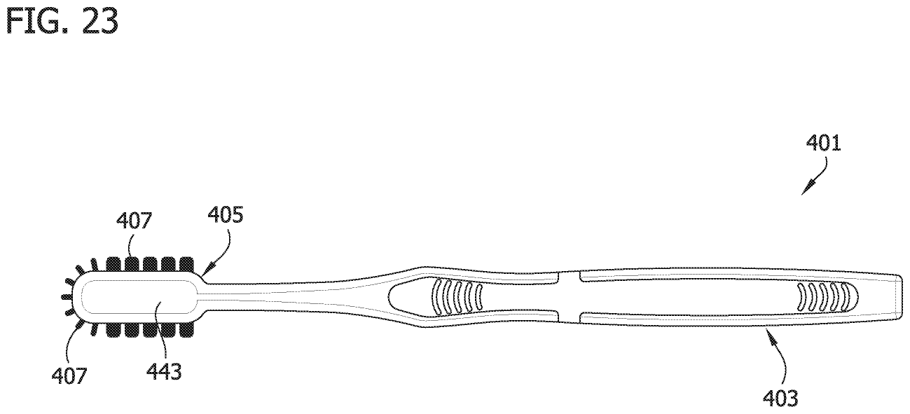

FIGS. 20-28 illustrate another embodiment of a toothbrush, generally designated 401. The tooth brush 101 includes a handle 403 and a head 405 connected to an end of the handle. The handle 403 is suitably a conventional handle. The handle 403 is an elongate member sized and shaped to fit comfortably in a person's hand (not shown) while the person holds the toothbrush 401 so the head 405 is inside the person's mouth. The size and shape of the handle can vary from what is shown in the drawings if desired.

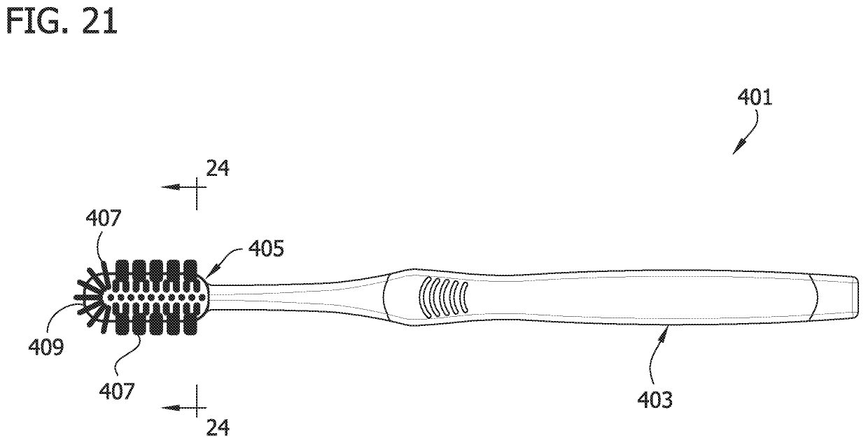

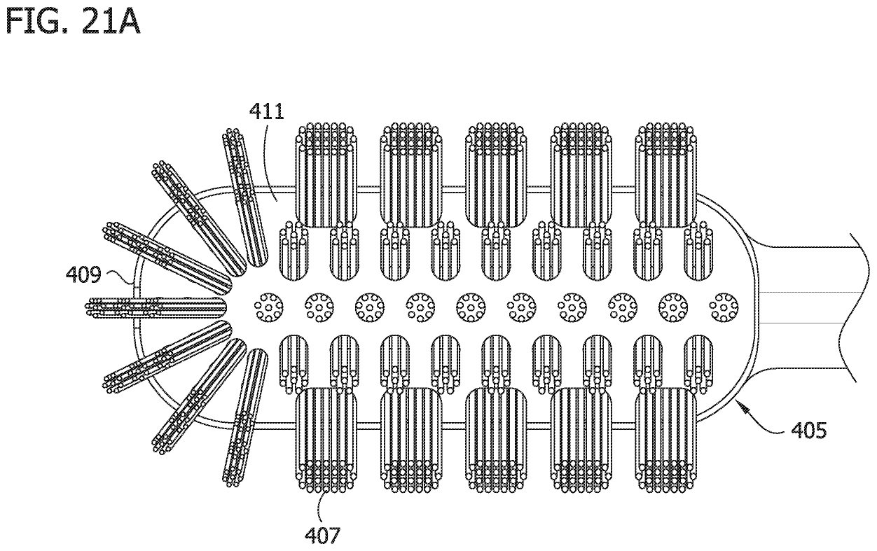

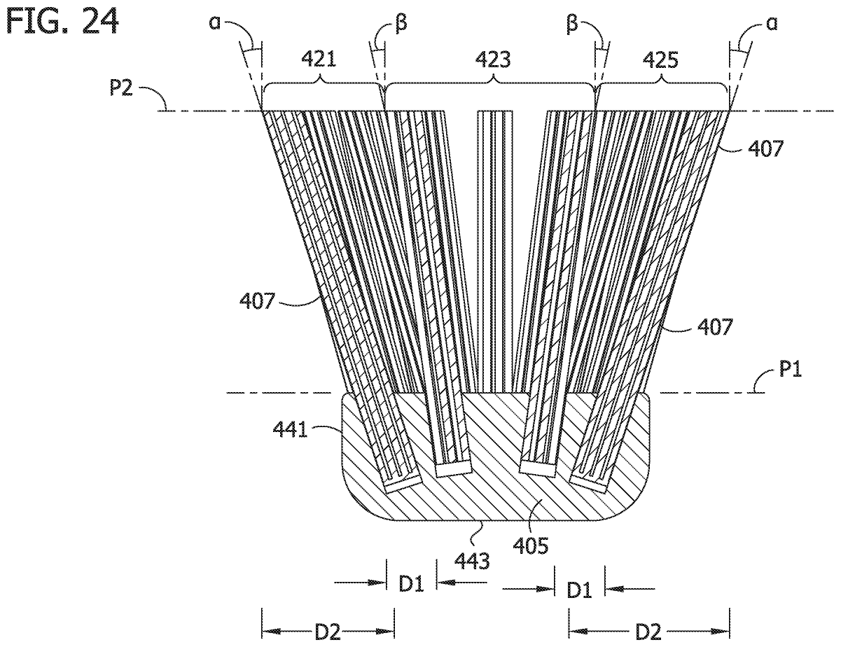

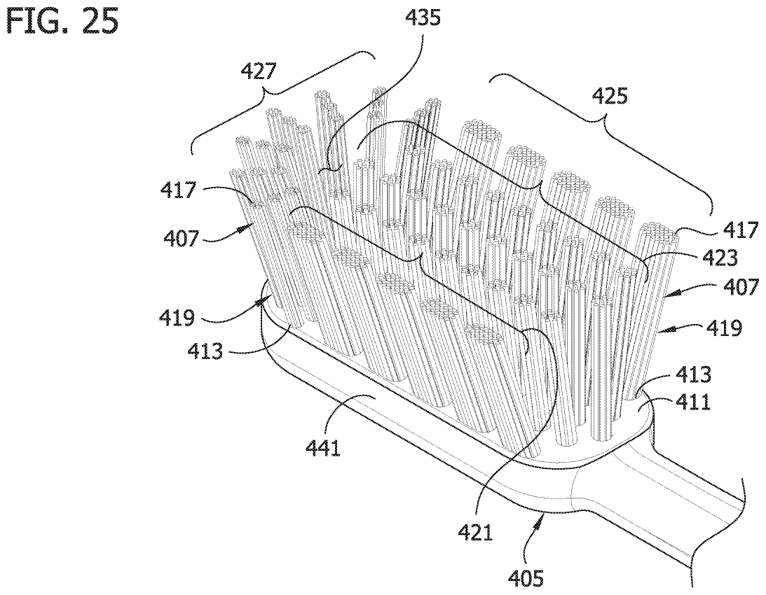

The head 405 of the toothbrush 401 includes a flat surface 411 (see FIGS. 21A, 25, and 26) for carrying a plurality of bristles 407 thereon. The flat surface 411 may be referred to as an “upper” surface herein for convenience, but it is understood the orientation of the toothbrush 401 can be changed from what is shown in the drawings and that the flat surface can be on the side or bottom of the toothbrush depending on how it is held. The head 405 is suitably formed integrally with the handle 403. For example, the head 405 and handle 403 are suitably molded together as one-piece from a polymeric material. The end 409 of the head 405 opposite the handle 403 is suitably rounded, as illustrated in FIGS. 21-23. Referring to FIGS. 24 and 25, the head 405 suitably has flat sides 441. The sides 441 are suitably substantially parallel to one another and substantially parallel to the longitudinal axis of the handle 403.

The head 405 also has a surface 443, which may be referred to herein as the “bottom” of the toothbrush head (see FIGS. 22-24) that is opposite the flat “upper” surface 411. The shape of the bottom surface 443 can vary. However, in the illustrated embodiment, the bottom surface 443 is flat. Referring to FIG. 24, the head 405 of the toothbrush 101 suitably has a cross sectional shape that is substantially rectangular. For example, the flat upper surface 411 is suitably substantially rectangular, as indicated by the fact the points on the flat upper surface in FIG. 24 all lie on the same plane P1. The bottom surface 443 is also suitably substantially rectangular. The sides 441 are suitably rectangular and provide a transition between the upper and lower surfaces 411, 443, which results in a generally rectangular cross sectional shape that includes rounded bottom corners. However, it is understood the cross sectional shape may be different from what is illustrated in the drawings, including without limitation an oval shape or any other suitable geometrical shape.

The bristles 407 are mounted on the head 405 so the bristles extend from the flat surface 411. For example, in the illustrated embodiment, the bristles 407 are arranged so they only extend from one side of the head 405. For example, there are suitably no bristles extending from the bottom surface 443 of the head 405. The bristles 407 each have a base 413 that extends through an opening 415 in the flat surface 411 and a distal end 417 spaced from the flat surface. The bristles 407 are suitably arranged in tufts 419. For example, each tuft 419 is suitably formed by a group of bristles 407 arranged so the multiple bristles in that group all extend through a single one of the openings 415 in the flat surface 411.

Referring to FIGS. 24 and 25, the bristles 407 are arranged in multiple different sets. As illustrated in FIG. 25, the bristles are arranged in first, second, third, and fourth sets 421, 423, 425, 427. The first, second, and third sets 421, 423, 425 are visible in FIG. 24. The fourth set 427 is located at the end of the toothbrush head 405 opposite the handle 403 and is visible in FIG. 25, but not in FIG. 24. It is understood that the number of sets can vary if desired. Also, one or more of the sets can be subdivided into subsets if desired. Therefore, a single set of bristles can include less than all of the bristle 407 illustrated in each of the sets.

Referring to FIGS. 24 and 25, the bristles 407 in each of the first 421, second 423, and third 425 sets are arranged in longitudinal rows of tufts 419 of bristles extending along a longitudinal axis of the head 405. The bristles 407 in each row of the first 421, second 423, and third 425 sets are substantially parallel to the other bristles in the same row. The bristles 407 in the first 421, second 423, and third 425 sets are also arranged so the bristles in each set are in a generally rectangular formation extending generally parallel to the handle 403. For example, the bristles 407 in the first 421, second 423, and third 425 sets are suitably arranged in longitudinal rows that are substantially parallel to the handle 403. A single set may include a single longitudinal row of bristles 407 or less than all the bristles within a single longitudinal row.

The bristles 401 in the second set 423 are arranged in three longitudinal rows of tufts 419 of bristles 407. A first, middle row of bristles 407 extends generally along a center of the flat surface 411 and orthogonally from the surface. The second and third rows of bristles 407 are laterally spaced from the first, middle row and are angled outwardly from the bristles 407 in the first row. Thus, the bristles 407 in the second and third rows are arranged so they intersect the flat surface 411 of the toothbrush head 405 at one or more non-orthogonal angles β (FIG. 24). For example, the bristles in the second and third rows extend at an angle β relative to a vertical axis between about 1 and about 16 degrees. In one embodiment, angle β is about 8 degrees.

The bristles 407 in the first and third sets are each defined by a single longitudinal row of tufts 419 of bristles 407. The bristles 407 in the first 421 and third 425 sets are suitably oriented so they angle outwardly from the bristles in the second set 423 as they extend away from the flat surface 411. Referring to FIG. 24, a distance D1 between the bases 413 of the bristles 407 in the first set 421 and the adjacent bases of the bristles in the second set 423 is less than the distance D2 between the distal ends 417 of the bristles in the first set and the distal ends of the bristles in the second set. Accordingly, there is a gap between the distal ends 417 of the bristles 407 in the first set 421 and the distal ends of the bristles in the second set 423. Also, the distance D1 between the bases 413 of the bristles 407 in the third set 425 and the adjacent bases of the bristles in the second set 423 is less than a distance D2 between the distal ends 417 of the bristles in the third set and the distal ends of the bristles in the second set. Thus, there is another gap between the distal ends 417 of the bristles 407 in the second set 423 and the distal ends of the bristles in the third set 425. The gaps between the ends 417 of the bristles 407 in the second set 423 and the first and third sets 425 are suitably oriented to extend generally parallel to the handle 403. In the illustrated embodiment, the gaps are substantially equal in width. The gaps are also suitably substantially uniform in width along the entire length of the gaps.

Still referring to FIG. 24, the bristles 407 in the first set 421 and third set 425 are arranged so they intersect the flat surface 411 of the toothbrush head 405 at one or more non-orthogonal angles α. For example, the bristles in the first and third sets 421, 425 extend at an angle α relative to a vertical axis between about 1 and about 28 degrees. In one embodiment, angle α is between about 16 and about 28 degrees. In one embodiment, angle α is between about 16 and about 18 degrees.

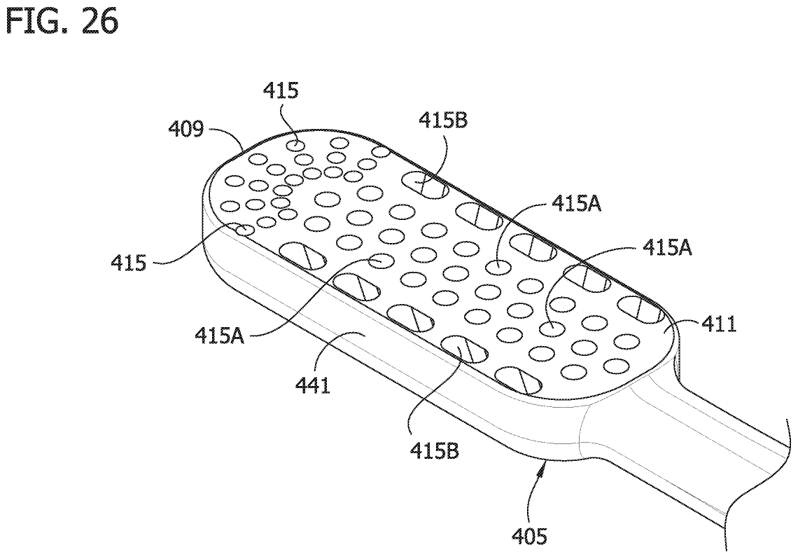

Referring to FIGS. 25 and 26, the openings 415 in the flat surface 411 for the bristles 407 in the first 421, second 423, and third 425 sets are arranged in an array. The openings 415 contain tufts 419 of bristles that define the first 421, second 423, and third 425 sets of bristles. The array of openings 415 is configured so round openings 415A associated with the second set 423 of bristles 407 are arranged in rows extending generally transverse to the handle 403 and columns extending generally parallel to the handle. The openings 415A in each row associated with the second set 423 of bristles 407 are spaced from one another at substantially uniform intervals along the row. The openings 415A in each column associated with the second set 423 of bristles 407 are also spaced from one another at substantially uniform intervals. In the illustrated embodiment, there are 10 openings 415A in the middle column of openings forming 10 tufts 419 of bristles, and 9 openings in each of the two outside columns of openings 415A forming 9 tufts in each of the outside columns. The openings 415A (FIG. 27) in the outside columns associated with the second set 423 of bristles 407 are inclined or angled outwardly so that the bristles extend outward at the angle β previously described. In one embodiment, each column of openings 415A can include at least three openings forming at least three tufts of bristles in each column. The array of openings 415 also includes elongate openings 415B associated with the first and third sets 421, 2425 of bristles 407. The openings 415B associated with the first set 421 are defined by a single column of openings. The openings 415B associated with the third set 425 are also defined by a single column of openings. The openings 415B associated with the bristles 407 in the first and third sets 421, 425 are angled outwardly so that the bristles extend outward at the angle α preciously described (FIG. 27).

Referring to FIG. 25, the bristles 407 in the fourth set 427 are positioned so the bristles in the first 421, second 423, and third 425 sets are located between the fourth set and the handle 403. For example, the bristles 407 in the fourth set are suitably positioned on the rounded end 409 of the toothbrush head 405. The bristles 407 in the fourth set 427 are suitably arranged in an arcuate configuration. For example, the bristles 407 in the fourth set 427 suitably include a band of bristles extending in an arcuate configuration from an end of the first 421 set to and end of the third set 425. Thus, there is an arcuate gap 435 between the fourth set 427 of bristles 407 and the second set 423 of bristles. In the illustrated embodiment, the arcuate configuration is formed by a plurality of linear rows of tufts 419 of bristles arcuately 407 spaced from each other. In one embodiment, the arcuate configuration is defined by at least three spaced apart linear rows of bristles 407.

The lengths of the bristles 107 in the first through fourth sets 421, 423, 425, 427 are varied so that the distal ends 417 of the bristles 407 collectively form a planar brushing surface. As illustrated in FIG. 24 for example, the distal ends 417 of the bristles all lie in a plane P2. Relatedly, the bristles 407 in the first 421 and third 425 sets are longer than the bristles in the second set 423. Meanwhile, the bristles in the fourth set 427 are also longer than the bristles in the second set 423.

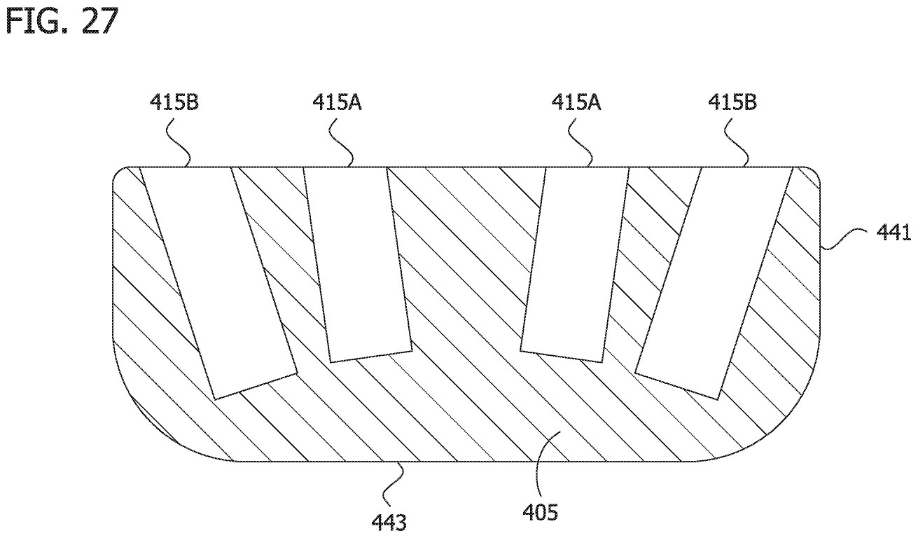

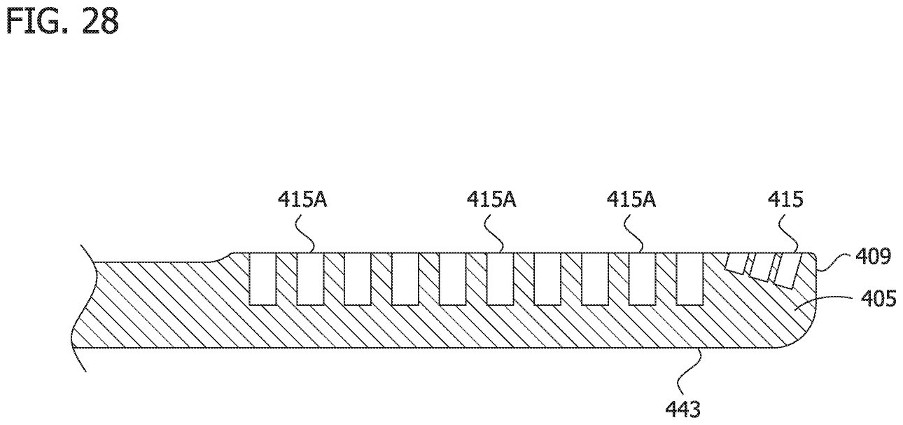

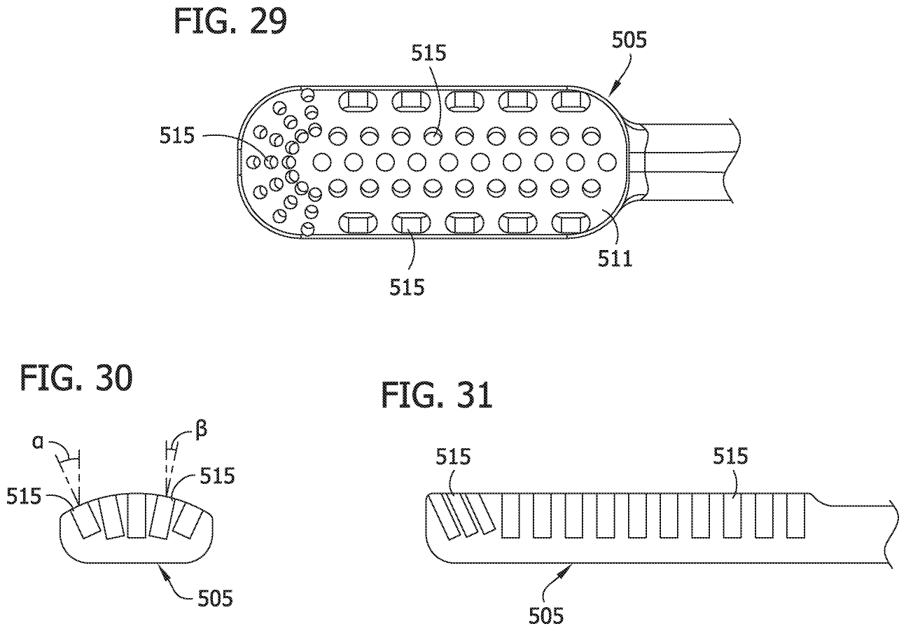

FIGS. 29-31 illustrate another embodiment of a toothbrush head, generally designated 505, which is substantially identical to the toothbrush head 405 described above except as noted. In this embodiment, an upper surface 511 of the head 505 is convex. Openings 515 are arranged such that bristles (not shown) in a first and third set are arranged so they intersect the convex surface 511 of the toothbrush head 505 at one or more non-orthogonal angles α. For example, the bristles in the first and third sets extend at an angle α relative to a vertical axis between about 1 and about 28 degrees. In one embodiment, angle α is between about 1 and about 25 degrees. In one embodiment, angle α is about 18 degrees. Additionally, the openings 515 are arranged such that the bristles in the outer rows of the second set are arranged so they intersect the convex surface 511 of the toothbrush head 505 at one or more non-orthogonal angles β. For example, the bristles in the outer rows of the second set extend at an angle β relative to a vertical axis between about 1 and about 16 degrees. In one embodiment, angle β is about 8 degrees.

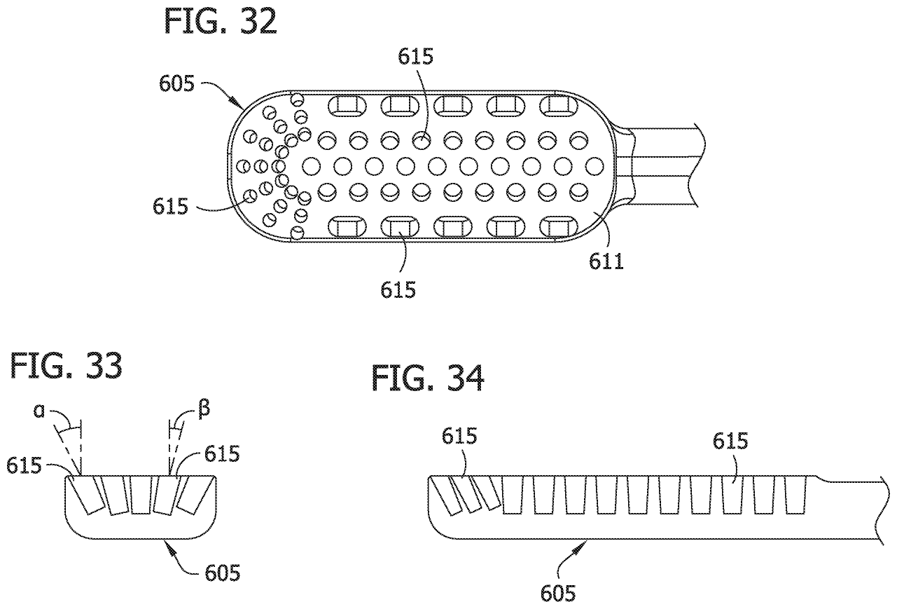

FIGS. 32-34 illustrate another embodiment of a toothbrush head, generally designated 605, which is substantially identical to the toothbrush head 405 described above except as noted. Openings 615 have a trapezoidal cross-sectional shape. The openings 615 are arranged such that bristles (not shown) in a first and third set are arranged so they intersect flat surface 611 of the toothbrush head 605 at one or more non-orthogonal angles α. For example, the bristles in the first and third sets extend at an angle α relative to a vertical axis between about 1 and about 28 degrees. In one embodiment, angle α is between about 1 and about 25 degrees. In one embodiment, angle α is about 18 degrees. Additionally, the openings 615 are arranged such that the bristles in the outer rows of the second set are arranged so they intersect the flat surface 611 of the toothbrush head 605 at one or more non-orthogonal angles β. For example, the bristles in the outer rows of the second set extend at an angle β relative to a vertical axis between about 1 and about 16 degrees. In one embodiment, angle β is about 8 degrees.

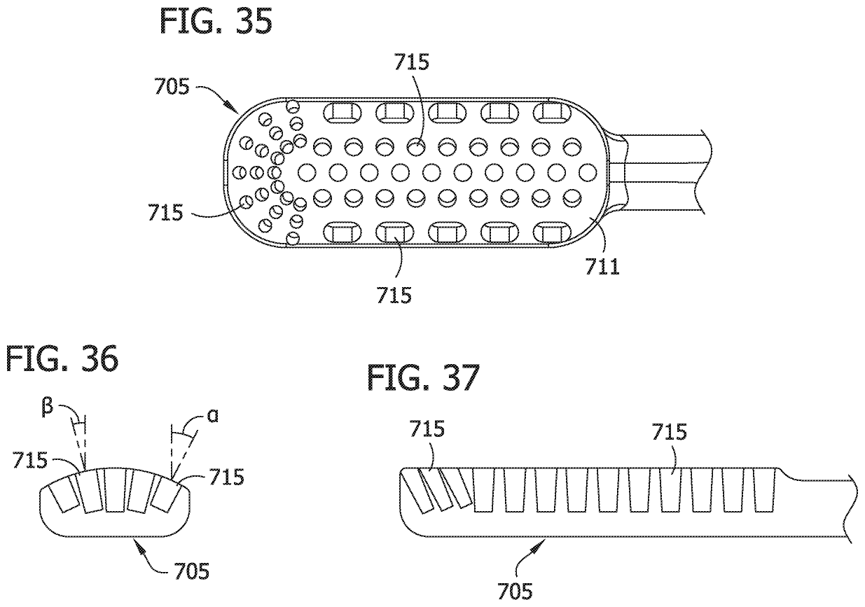

FIGS. 35-37 illustrate another embodiment of a toothbrush head, generally designated 705, which is substantially identical to the toothbrush head 405 described above except as noted. In this embodiment, an upper surface 711 of the head 705 is convex. Openings 715 in the convex surface 711 have a trapezoidal cross-sectional shape. The openings 715 are arranged such that bristles (not shown) in a first and third set are arranged so they intersect the convex surface 711 of the toothbrush head 705 at one or more non-orthogonal angles α. For example, the bristles in the first and third sets extend at an angle α relative to a vertical axis between about 1 and about 28 degrees. In one embodiment, angle α is between about 1 and about 25 degrees. In one embodiment, angle α is about 18 degrees. Additionally, the openings 715 are arranged such that the bristles in the outer rows of the second set are arranged so they intersect the convex surface 711 of the toothbrush head 705 at one or more non-orthogonal angles β. For example, the bristles in the outer rows of the second set extend at an angle β relative to a vertical axis between about 1 and about 16 degrees. In one embodiment, angle β is about 8 degrees.

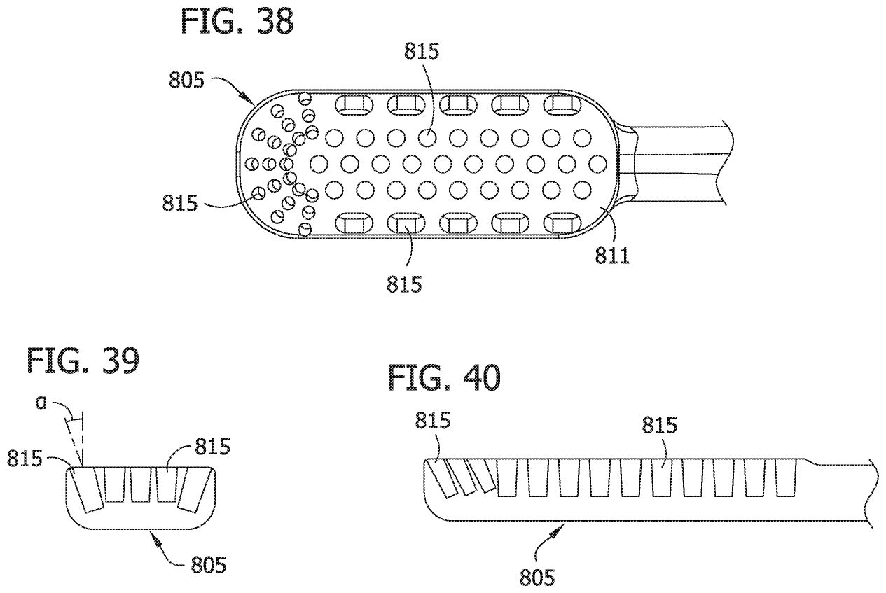

FIGS. 38-40 illustrate another embodiment of a toothbrush head, generally designated 805, which is substantially identical to the toothbrush head 405 described above except as noted. Openings 815 have a trapezoidal cross-sectional shape. The openings 815 are arranged such that bristles (not shown) in a first and third set are arranged so they intersect flat surface 811 of the toothbrush head 805 at one or more non-orthogonal angles α. For example, the bristles in the first and third sets extend at an angle α relative to a vertical axis between about 1 and about 28 degrees. In one embodiment, angle α is between about 1 and about 25 degrees. In one embodiment, angle α is about 17 degrees. Additionally, the openings 815 are arranged such that the bristles in the second set are arranged so they intersect the flat surface 811 of the toothbrush head 805 at an orthogonal angle.

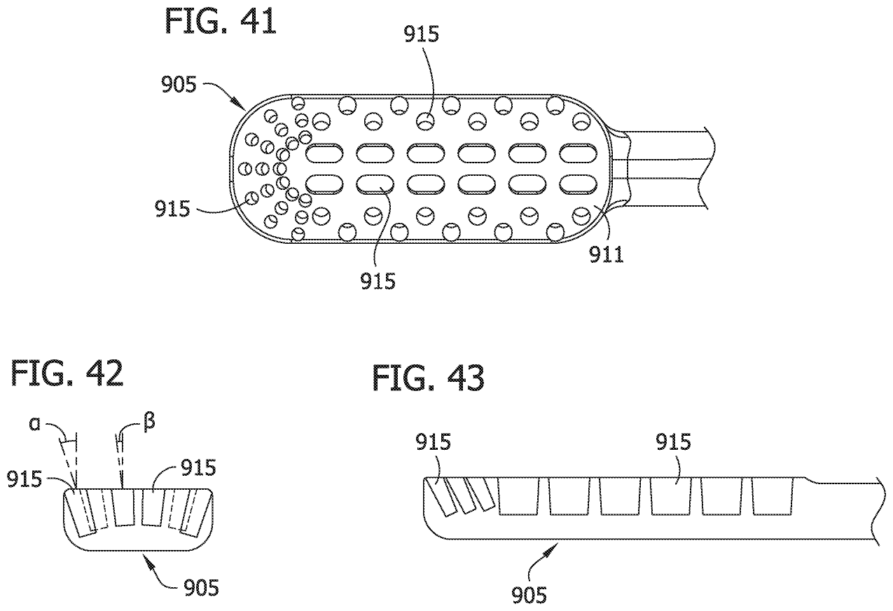

FIGS. 41-43 illustrate another embodiment of a toothbrush head, generally designated 905, which is substantially identical to the toothbrush head 405 described above except as noted. Openings 915 have a trapezoidal cross-sectional shape. The openings 915 are arranged such that bristles (not shown) in a first and third set are arranged so they intersect flat surface 911 of the toothbrush head 905 at one or more non-orthogonal angles α. For example, the bristles in the first and third sets extend at an angle α relative to a vertical axis between about 1 and about 28 degrees. In one embodiment, angle α is between about 1 and about 25 degrees. In one embodiment, angle α is about 16 degrees. Additionally, the openings 915 are arranged such that the bristles in the second set are arranged so they intersect the flat surface 911 of the toothbrush head 905 at one or more non-orthogonal angles β. For example, the bristles in the two rows of the second set extend at an angle β relative to a vertical axis between about 1 and about 16 degrees. In one embodiment, angle β is about 4 degrees. In the illustrated embodiment, the openings 915 associated with the second set are elongate, and the openings associated with the first and third sets are round.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatuses, systems, and methods without departing from the scope of the invention, it is intended that all matter contained in the above description and shown in the accompanying drawings shall be interpreted as illustrative and not in a limiting sense.

1. A toothbrush comprising:
a handle;
a head connected to an end of the handle, the head having a surface; and
a plurality of bristles mounted on the head so the bristles extend from the surface on only one side of the head,
wherein the plurality of bristles are arranged in a plurality of sets comprising first, second, and third sets, the bristles of each of the first, second, and third sets being substantially parallel to other bristles in the same respective set, the bristles of the second set being defined by a plurality of laterally spaced apart longitudinal rows of bristles, each row of bristles in the second set being defined by at least three tufts each comprised of multiple bristles, the bristles of each of the first and third sets being defined by at least one longitudinal row of bristles, the bristles in the first and third sets being oriented to angle outwardly from the bristles in the second set as they extend away from the surface.

2. A toothbrush as set forth in claim 1 further comprising openings in the surface, wherein the openings in the surface for the bristles in the first, second, and third sets are arranged in an array configured so the openings are arranged in rows extending generally transverse to the handle and columns extending generally parallel to the handle, and wherein the openings in each row are spaced from one another at substantially uniform intervals and include openings that contain bristles in the first, second, and third sets.

3. A toothbrush as set forth in claim 2 wherein the openings in each column are spaced from one another at substantially uniform intervals and the openings in each column contain bristles from only a single one of said first, second, and third sets.

4. A toothbrush as set forth in claim 2 wherein the bristles in the first, second, and third sets are arranged in tufts comprised of multiple bristles, the bristles of each tuft extending through a single one of the openings in the surface.

5. A toothbrush as set forth in claim 2 wherein said plurality of sets of bristles further comprises a fourth set, the fourth set being positioned so the first, second, and third sets are located between the fourth set and the handle and wherein the plurality of bristles in said fourth set are arranged in an arcuate configuration, the plurality of bristles in the fourth set being arranged in multiple spaced apart linear rows of bristles.

6. A toothbrush as set forth in claim 5 wherein the bristles in said fourth set include a band of bristles extending in an arcuate configuration extending from an end of the first set to and end of the third set.

7. A toothbrush as set forth in claim 6 wherein the bristles in said fourth set further comprise a group of bristles spaced inward from said band and located adjacent an end of the second set of bristles, said group of bristles being defined by at least three tufts of bristles.

8. A toothbrush a set forth in claim 1 wherein the bristles in the first and third sets are arranged so they intersect the surface at one or more non-orthogonal angles.

9. A toothbrush as set forth in claim 8 wherein the bristles in the first and third sets are arranged so they intersect the surface at an angle to a vertical axis of between about 16 and about 28 degrees.

10. A toothbrush as set forth in claim 1 wherein the bristles in said first, second, and third sets have distal ends positioned to lie on a planar brushing surface.

11. A toothbrush as set forth in claim 1 wherein the bristles in said first, second, and third sets have distal ends positioned to lie on a concave brushing surface.

12. A toothbrush as set forth in claim 1 wherein the bristles in said first, second, and third sets have distal ends positioned to lie on a convex brushing surface.

13. A toothbrush comprising:
a handle;
a head connected to an end of the handle, the head having a surface; and
a plurality of bristles mounted on the head so the bristles extend from the surface on only one side of the head,
wherein the plurality of bristles are arranged in a plurality of sets comprising first, second, and third sets, the bristles of each of the first, second, and third sets being defined by at least one longitudinal row of bristles, the bristles in the first and third sets being oriented to angle outwardly from the bristles in the second set as they extend away from the surface, the plurality of sets of bristles further comprising a fourth set being positioned so the first, second, and third sets are located between the fourth set and the handle and wherein the plurality of bristles in said fourth set are arranged in an arcuate configuration defined by at least three spaced apart linear rows of bristles.

14. A toothbrush as set forth in claim 13 wherein the bristles in said fourth set include a band of bristles extending in an arcuate configuration extending from an end of the first set to and end of the third set.

15. A toothbrush as set forth in claim 14 wherein the bristles in said fourth set further comprise a group of bristles spaced inward from said band and located adjacent an end of the second set of bristles, said group of bristles being defined by at least three tufts of bristles.
